(19) United States
(12) Patent Application Publication
(10) Pub. No.: US 2014/0040233 A1
(43) Pub. Date: Feb. 6, 2014

(54) ORGANIZING CONTENT

(71) Applicants: Mehmet Kivanc Ozonat, San Jose, CA (US); Claudio Bartolini, Palo Alto, CA (US)

(72) Inventors: Mehmet Kivanc Ozonat, San Jose, CA (US); Claudio Bartolini, Palo Alto, CA (US)

(21) Appl. No.: 13/563,108

(22) Filed: Jul. 31, 2012

(51) Int. Cl. G06F 17/30

(52) U.S. Cl. 707/709; 707/737; 707/E17.089; 707/E17.108

(57) ABSTRACT

Methods, systems, and computer-readable and executable instructions are provided for organizing content. A method for organizing content can include building a customized content corpus for a user, building a concept graph customized for the user's context based on the customized corpus, and organizing, utilizing multi-view clustering, the content within the corpus based on the concept graph.

### BACKGROUND

As the number of Generation Y and millennial employees increases within corporate environments, so does the trend toward consumerization and self-help. Many employees use social networking sites to resolve issues they encounter with home computers, appliances, and automobiles, for example. The same employees may follow a similar process when a problem or issue arises while at work.

### BRIEF DESCRIPTION OF THE DRAWINGS

FIG. 1 is a block diagram illustrating an example of a method for organizing content according to the present disclosure.

FIG. 2 is a block diagram illustrating an example semantics graph according to the present disclosure.

FIG. 3 is a block diagram illustrating a processing resource, a memory resource, and computer-readable medium according to the present disclosure.

### DETAILED DESCRIPTION

Users frustrated with corporate helpdesks are utilizing internet searches and social media sites for support purposes. There is a wealth of support-related content available publicly; supplier's web sites, blogs, and product forums are just some examples. Organizing this content can include the use of a platform that utilizes the publicly available content to automatically answer corporate users' support questions.

An automated platform that uses social media to answer support questions can understand the context in which a question is being asked, find and retrieve resources in the social media where the question has been discussed, and organize the content retrieved from the social media resources in a user-friendly way. Statistical clustering and data mining techniques can be utilized to address the understanding, finding and retrieving, and organizing components of the automated platform.

Examples of the present disclosure may include methods, systems, and computer-readable and executable instructions and/or logic. An example method for organizing content can include building a customized content corpus for a user, building a concept graph customized for the user's context based on the customized corpus, and organizing, utilizing multi-view clustering, the content within the corpus based on the concept graph.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “N”, “P,” “R”, and “S” particularly with respect to reference numerals in the drawings, indicate that a number of the particular feature so designated can be included with a number of examples of the present disclosure. Also, as used herein, “a number of an element and/or feature can refer to one or more of such elements and/or features.

A research and development engineer at a particular organization is unlikely to have the same hardware and software requirements and needs as, for example, a human resources manager at a different organization. In order for a platform (e.g., automated platform) to be used to answer support questions based on content from social media, the platform should have knowledge of the information technology (IT) assets of each user, and leverage this knowledge to better understand the context in which the users ask their question.

Finding resources in the social media where the question has been discussed can include the use of websites internal to an organization, as well as external websites. There are billions of websites on the world-wide web, so it is an unfruitful effort to blindly crawl and retrieve every piece of content. Crawlers that retrieve content from social media platforms can be designed such that they “know” where to look for information on each social platform. These crawlers may be referred to as directed crawlers.

Presenting the user with all of the data in an unorganized form may be of use to the user; therefore, the data (e.g., an answer to a user's question) can be presented to the user in an organized, easy-to-navigate way. Statistical clustering and data mining techniques can be applied to create an automated platform that answers support questions based on content from social media.

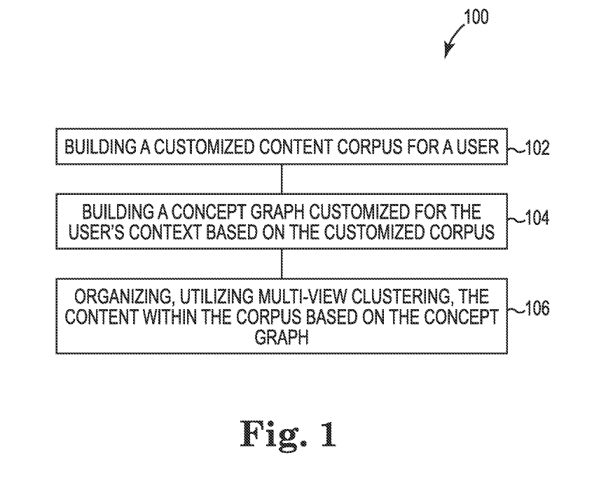

FIG. 1 is a block diagram illustrating an example of a method 100 for organizing content according to the present disclosure. At 102, a customized content corpus (e.g., repository) is built for a user. For each user, (e.g., a corporate customer, an employee at a corporate customer, etc.) a set of seed URLs of the user's main corporate IT support sites may be available. Each user's organization, job function, and/or devices and business applications used for work may also be available, among others. This information may be collected from a number of sources including, for example, directory services, IT asset management systems, and/or desktop management systems. The user's internal IT sites can be crawled, starting from the set of seed URLs. The crawler can be directed, (e.g., it focuses on hardware and/or software the user uses and/or is likely to use in his or her work). The directed crawler can retrieve content from the user's IT support sites (as well as any IT collaboration sites) that may be likely to be of relevance to the user's environment. The retrieved content constitutes the customized, user-centric corpus.

Concepts can be extracted in a number of ways. Concept extraction can include extracting (e.g., automatically extracting) structured information from unstructured and/or semi-structured computer-readable documents, for example. Concept extraction techniques can be based on the term frequency/inverse document frequency (TD/IDF) method. The TD/IDF method compares concept (e.g., word) frequencies in a corpus and/or repository with concept frequencies in sample text; if the frequency of a concept in the sample text is higher as compared to its frequency in the corpus and/or repository, (e.g., meets and/or exceeds some threshold) the concept is extracted and/or designated as a keyword and/or key concept.

However, a forum thread may contain a limited number of sentences and words. This can result in an inability to obtain reliable statistics based on word frequencies. A number of relevant words may appear only once in the thread, for example, making them indistinguishable from other, less relevant words of the thread.

Utilizing a vector of concepts can result in increasingly accurate concept extraction. For example, a vector of concepts can be formed in a corpus and/or repository of forum threads, and a binary features vector for each thread can be generated. If the ith corpus and/or repository concept appears in the thread, the ith element of the thread's feature vector is 1, and if the concept does not appear in the thread, the ith element of the thread's feature vector is 0, for example. A number of different approaches can be used to generate concepts in a given corpus and/or repository.

In some examples, when generating concepts, stop words (e.g., if, and, we, etc.) can be filtered from a corpus and/or repository, and a vector of concepts can be the set of all remaining distinct corpus and/or repository words. In a number of embodiments, only stop words are filtered from the corpus and/or repository.

In some embodiments of the present disclosure, the TF/IDF method can be applied to the entire corpus and/or repository by comparing the concept (e.g., word) frequencies in the corpus and/or repository with concept frequencies in the English language when generating concepts. For example, if the frequency of a concept is higher in the corpus and/or repository (e.g., meets and/or exceeds some threshold) in comparison to the English language (e.g., and/or other applicable language), the concept can be taken as a key concept and/or keyword.

Concepts can be extracted from the corpus using co-occurrence based techniques. For example, the concepts can include single words as well as n-tuples, where n>1. In some examples, generating concepts can include utilizing term co-occurrence. A term co-occurrence method can include extracting concepts from a corpus and/or repository without comparing the corpus and/or repository frequencies with language frequencies.

For example, let N denote a number of all distinct words in the corpus and/or repository of forum threads. An N×M co-occurrence matrix can be constructed, where M is a pre-selected integer with M<N. In an example, M can be 500. Distinct words (e.g., all distinct words) can be indexed by n, (e.g., 1≦n≦N). The most frequently observed M words can be indexed in the corpus and/or repository by m such that 1≦m≦M. The (n:m) element (e.g., nth row and the mth column) of the N×M co-occurrence matrix counts the number of times the word n and the word m occur together.

In an example, the word “wireless” can have an index n, the word “connection” can have an index m, and “wireless” and “connection” can occur together 218 times in the corpus and/or repository; therefore, the (n:m) element of the co-occurrence matrix is 218. If the word n appears independently from the words 1≦m≦M (e.g., the frequent words), the number of times the word n co-occurs with the frequent words is similar to the unconditional distribution of occurrence of the frequent words. On the other hand, if the word n has a semantic relation to a particular set of frequent words, then the co-occurrence of the word n with the frequent words is greater than the unconditional distribution of occurrence of the frequent words. The unconditional probability of a frequent word m can be denoted as the expected probability pₘ, and the total number of co-occurrences of the word n and frequent terms can be denoted as cₙ. Frequency of co-occurrence of the word n and the word m can be denoted as freq(n,m). The statistical value of x² can be defined as:

$${x}^{2} ( n ) = {\sum }_{1 \leq m \leq M}^{ } \frac{freq ( n , m ) - {N}_{n} {p}_{m}}{{n}_{m} {p}_{m}} .$$

As will be discussed further herein, two or more frequent terms can be clustered. Content can be clustered, for example, if the frequent words m₁ and m₂ co-occur frequently with each other and/or the frequent words m₁ and m₂ have a same and/or similar distribution of co-occurrence with other words. To quantify the first condition of m₁ and m₂ co-occurring frequently, the mutual information between the occurrence probability of m₁ and m₂ can be used. To quantify the second condition of m₁ and m₂ having a similar distribution of co-occurrence with other words, the Kuliback-Leibler divergence between the occurrence probability of m₁ and m₂ can be used.

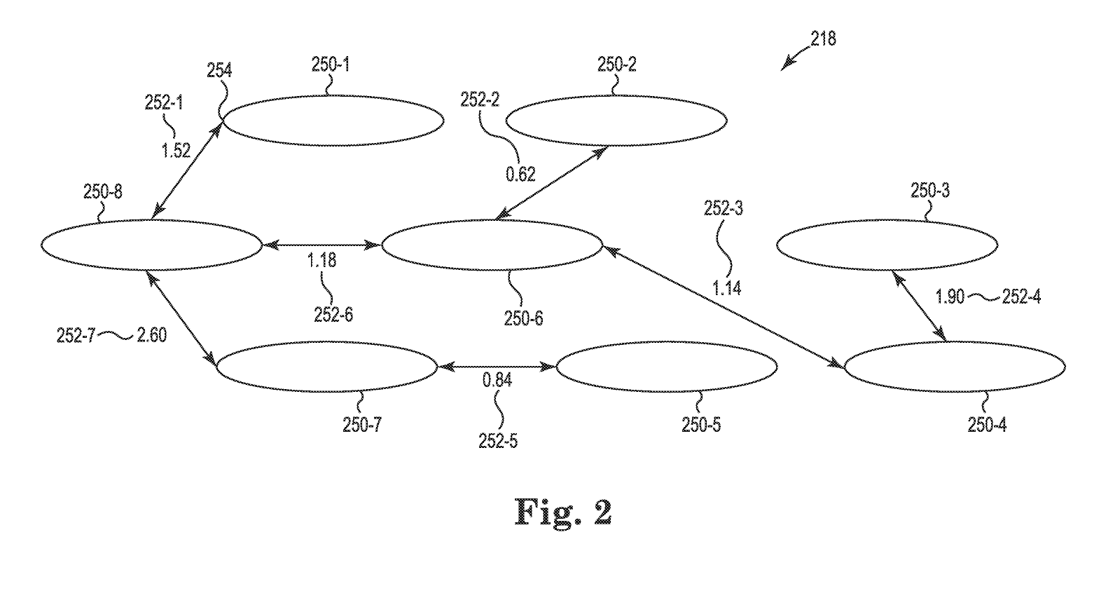

At 104, a concept graph customized for the user's context is built based on the customized corpus. The concept graph can allow for an ability to understand a context in which a user has asked his or her question, for example. The concept graph can include a semantics graph that reflects relations between the extracted concepts, as will be discussed further herein with respect to FIG. 2.

Extracting concepts and their relations can allow for a platform to understand a concept in which a user asks an IT support question. Through directed crawling, the corpus can be focused to the customer's IT support pages that are most relevant to the individual user. This can help extract concepts and concept relations specific to the user's context and environment. Platforms in the social media that may be of relevance to IT technical support can be identified, and for each platform, a crawler can be designed that retrieves content to a corpus and/or repository from the platform. Since the crawler is designed specifically for the platform, it “knows” which parts of the site to focus on (e.g., which links are more likely to contain technical support discussions).

At 106, the content within the corpus is organized based on the concept graph and utilizing multi-view clustering. The content retrieved from the social media resources may include more information than a user desires (e.g., too much redundant information), since the question being asked may have been discussed in multiple social platforms, for example. Statistical clustering techniques can be applied to organize the content into clusters. Further, a hierarchical clustering approach which organizes the content in a tree structure can be used, so that the user can navigate between the clusters.

For instance, the user can initially select the expected number of entries in each cluster, and if the user then decides to increase the number of entries, he or she can navigate to the parent nodes, or if he or she decides to reduce the number of entries, he or she can navigate to the children nodes without having to reconstruct the clustering tree. It is noted that the retrieved content from a social platform may have multiple views. For example, if the content is being retrieved from a forum, there may be a number of views, including a thread title and a thread content. The thread title (often consisting of just a few words) may have a very different characteristic than the thread content (often consisting of at least several sentences), making it infeasible to combine the two into a vector (e.g., a feature vector) to feed into a single clustering algorithm. To address the issue that the retrieved content has multiple views, a set of clustering techniques called multi-view clustering techniques can be utilized.

In multi-view clustering, each view can have its own clustering model (e.g., algorithm), and the models can be dependent on each other. For example, a clustering tree based on each view can be created, and each clustering tree can be grown and pruned with feedback from other clustering trees. For instance, in the case of two views, thread titles and thread content, a penalty function can be introduced, and the two trees can be trained to reduce (e.g., minimize) the penalty function. The penalty function can be selected to be the clustering disagreement probability between the two trees with constraints on the entropy (e.g., size or depth) of the trees.

A Gauss mixture vector quantization (GMVQ) can be used to design a multi-view hierarchical (e.g., tree-structured) clustering model, and it can be extended to a multi-view setting. In a number of embodiments, views in the setting include thread titles and thread content.

For example, the training set {z_{i,} 1≦i≦N) can be considered with its (not necessarily Gaussian) underlying distribution f in the form f(Z)=Σₖpₖfₖ(Z). The goal of GMVQ may be to find the Gaussian mixture distribution, g, that minimizes the distance between f and g. A Gaussian mixture distribution g that can minimize this distance (e.g., minimizes in the Lloyd-optimal sense) can be obtained iteratively with the particular updates at each iteration.

Given μₖ, Σₖ, and pₖ for each cluster k, each z, can be assigned to the cluster k that minimizes

$$\frac{1}{2} log ( \vert {\sum }_{k}^{ } \vert + \frac{1}{2} {( {z}_{i} - {μ}_{k} )}^{T} {\sum }_{k}^{- 1} ( {z}_{i} - {μ}_{k} ) - log {p}_{k} ,$$

where |Σₖ| is the determinant of Σₖ.

Given the cluster assignments, μₖ, Σₖ, and pₖ can be set as:

$${μ}_{k} = \frac{1}{‖ {S}_{k} ‖} {\sum }_{{z}_{i} ∈ {S}_{k}}^{ } {z}_{i} , \\ {\sum }_{k}^{ } = \frac{1}{‖ {S}_{k} ‖} {\sum }_{i}^{ } ( {z}_{i} - {μ}_{k} ) {( {z}_{i} - {μ}_{k} )}^{T} , \\ and$$

$${p}_{k} = \frac{‖ {S}_{k} ‖}{N} ,$$

where Sₖ is the set of training vectors zᵢ assigned to cluster k, and ∥Sₖ∥ is the cardinality of the set.

A Breiman, Friedman, Olshen, and Stone (BFOS) model can be used to design a hierarchical (e.g., tree-structured) extension of GMVQ. The BFOS model may require each node of a tree to have two linear functionals such that one of them is monotonically increasing and the other is monotonically decreasing. Toward this end, a QDA distortion of any subtree, T, of a tree can be viewed as a sum of two functionals, u1 and u2, such that:

$${μ}_{1} ( T ) = \frac{1}{2} {\sum }_{ k ∈ T }^{ } {l}_{k} log ( \vert {\sum }_{k}^{ } \vert + \frac{1}{N} {\sum }_{ k ∈ T }^{ } {\sum }_{{z}_{i} ∈ {S}_{k}}^{ } \frac{1}{2} {( {z}_{i} - {μ}_{k} )}^{T} {\sum }_{k}^{- 1} ( {z}_{i} - {μ}_{k} ) , \\ and \\ {μ}_{2} ( T ) = - {\sum }_{k ∈ T}^{ } {p}_{k} log {p}_{k} ,$$

where kεT denotes the set of clusters (e.g., tree leaves) of the subtree T.

A magnitude of μ₂/μ₁ can increase at each iteration. Pruning can be terminated when the magnitude μ₂/μ₁ of reaches λ, resulting in the subtree minimizing ρ₁+λμ₂.

Clustering trees can be iteratively designed, one using thread title feature vectors, X_{i,1}, and the other using thread content feature vectors, X_{i,2}. At each iteration, the two trees are designed, including tree growing and tree pruning, joining to reduce (e.g., minimize) a disagreement probability with constraints on the entropy of clusters.

At each iteration, the tree growing can start with a single node tree out of which two child nodes can be grown. Lloyd updates (e.g., pₖ, u₁(T), u₂(T), and u₁^{m}(T)) can be applied to the child nodes, minimizing pₖ (e.g., assigning each training vector to a node). A node can be selected to be split into a pair of new nodes, and the selected node is the one, among all the existing nodes, that minimizes

$$\frac{1}{2} log ( \vert {\sum }_{k}^{ } \vert + \frac{1}{2} {( {z}_{i} - {μ}_{k} )}^{T} {\sum }_{k}^{- 1} ( {z}_{i} - {μ}_{k} ) - log {p}_{k} ,$$

after the split.

The Lloyd updates (e.g., pₖ, u₁(T), u₂(T), and u₁^{m}(T)) can be applied to each pair of new nodes, minimizing

$${\sum }_{{T}_{1}}^{ } {u}_{2}^{m} ( T ) = {R}_{v} .$$

This procedure of growing a pair of child nodes out of an existing node, and running the Lloyd updates within the new pair of nodes can be repeated until a fully-grown tree is obtained.

A title feature tree can be denoted by T₁, and a content feature tree by T₂. The trees, T₁ and T₂ can be designed using the BFOS model to minimize

$$\frac{1}{2} log ( \vert {\sum }_{k}^{ } \vert + \frac{1}{2} {( {z}_{i} - {μ}_{k} )}^{T} {\sum }_{k}^{- 1} ( {z}_{i} - {μ}_{k} ) - log {p}_{k} .$$

This can imply that, at iteration m, the subtree functionals for T₁ are:

$${u}_{1}^{m} ( T ) = {\sum }_{k ∈ {T}_{1}^{m}}^{ } {\sum }_{{x}_{i} ∈ {S}_{k}}^{ } P ( {α}_{1}^{m} ( {x}_{i , 1} ) \neq {α}_{1}^{m - 1} ( {x}_{i , 2} ) ) , \\ and$$

$${u}_{2}^{m} ( T ) = - {\sum }_{k ∈ {T}_{1}^{m}}^{ } {p}_{k} log {p}_{k} .$$

with the u₁ and u₂ functions for T₂ being analogous. Growing the tree can be addressed using the u₂^{m}(T) functional, and the functional:

$${\sum }_{{T}_{1}}^{ } {u}_{1}^{m} ( T ) = P ( {α}_{1}^{m} ( {X}_{1} ) \neq {α}_{2}^{m - 1} ( {X}_{2} ) ) ,$$

can be used during pruning, for example.

In some examples of the present disclosure, multi-view clustering can include growing a TS/GMVQ T₁ tree for training set X_{i,1}, using u₁ and u₂ as given in the u_{2hu m}(T) functional and the

$${\sum }_{{T}_{1}}^{ } {u}_{2}^{m} ( T ) = {R}_{v}$$

functional, respectively. A TS/GMVQ tree T₂ can be grown for training set X_{i,2}, analogously.

Given the tree T₂, fully-grown tree T₁ can be pruned, using the BFOS model with u₁ and u₂ as given in the

$${\sum }_{{T}_{1}}^{ } {u}_{1}^{m} ( T )$$

functional and u₂^{m}(T) functional, respectively. Given the tree T₁, fully-grown tree T₂ can be pruned analogously.

Multi-view clustering can be stopped if a cost function, given as:

$$\frac{1}{2} log ( \vert {\sum }_{k}^{ } \vert + \frac{1}{2} {( {z}_{i} - {μ}_{k} )}^{T} {\sum }_{k}^{- 1} ( {z}_{i} - {μ}_{k} ) - log {p}_{k} ,$$

from one iteration to the next is less than some ε threshold, for example. Threshold ε can be set such that the model stops if the change in the cost function is less than one percent from one iteration to the next, for example.

The organized content can be used to build a platform (e.g., engine) that can accept a support desk question as input, and outputs the questions/answers that best match the inputted IT question. For the questions/answers, the directed crawlers can build a corpus and/or repository that consist of a number of questions downloaded from a number of sources (e.g., an enterprise IT discussion forum). In some examples, the platform can have a number of sub-platforms. A first sub-platform can accept an IT question from the user as input, and can find the concepts from the semantics graph that best reflect the question. A second sub-platform can analyze each question/answer in the question/answer corpus and/or repository, and for each question/answer pair, it can find the concepts that reflect the pair. A third sub-platform can match the input question with the question/answer pairs in the corpus and/or repository based on the concepts and the graph.

As an example, in response to the user input, “I have a problem with configuring nginx. I want the nginx to make requests to the HTTP server to upload files. In the past, the HTTP server was responsible for the uploads and the requests,” the platform can extract “nginx”, “HTTP server,” and “upload” as concepts, and relate the “HTTP server” to another concept “Apache”. it can retrieve the following question (with its answer) from the corpus and/or repository, “I recently put nginx in front of apache to act as a reverse proxy. Up until now Apache handled directly the requests and file uploads. Now, I need to configure nginx so that it sends file upload requests to apache,” for example. This may be the closest question to the user input.

FIG. 2 is a block diagram illustrating an example semantics graph 218 according to the present disclosure. Nodes (e.g., nodes 250-1, . . . , 250-8) of the graph 218 are concepts, while the edges (e.g., edge 254) connecting the nodes have weights (e.g., weights 252-1, . . . , 252-7), representing distances between the concepts. A smaller distance between two concepts indicates that the two concepts are more highly related to each other. For example, nodes 250-2 and 250-6, with a weight 252-2 between them of 0.62 are more closely related to one another than node 250-6 and node 250-4 with a weight 252-3 of 1.14 between them. In computing the distances, a number of things can be considered. For example, how frequently two concepts appear in the same paragraphs, on the same pages, and on the pages that have links between them can be considered. For example, two concepts (e.g., tags) that appear more frequently (e.g., meet or exceed a particular threshold) will have their distance set smaller than two concepts that appear less frequently.

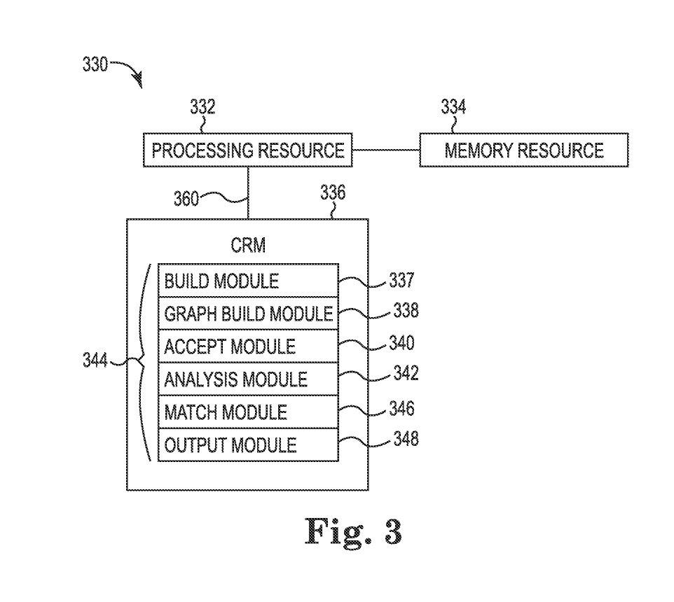

FIG. 3 is a block diagram illustrating a processing resource, a memory resource, and computer-readable medium according to the present disclosure. FIG. 3 illustrates an example computing device 330 according to an example of the present disclosure. The computing device 330 can utilize software, hardware, firmware, and/or logic to perform a number of functions.

The computing device 330 can be a combination of hardware and program instructions configured to perform a number of functions. The hardware, for example can include one or more processing resources 332, computer-readable medium (CRM) 336, etc. The program instructions (e.g., computer-readable instructions (CRI) 344) can include instructions stored on the CRM 336 and executable by the processing resources 332 to implement a desired function (e.g., organizing content, utilizing social media to answer support questions, etc.).

CRM 336 can be in communication with a number of processing resources of more or fewer than 332. The processing resources 332 can be in communication with a tangible non-transitory CRM 336 storing a set of CRI 344 executable by one or more of the processing resources 332, as described herein. The CRI 344 can also be stored in remote memory managed by a server and represent an installation package that can be downloaded, installed, and executed. The computing device 330 can include memory resources 334, and the processing resources 332 can be coupled to the memory resources 334.

Processing resources 332 can execute CRI 344 that can be stored on an internal or external non-transitory CRM 336. The processing resources 332 can execute CRI 344 to perform various functions, including the functions described in FIGS. 1 and 2.

The CRI 344 can include a number of modules, such as, for example, modules 337, 338, 340, 342, 346, and 348. Modules 337, 338, 340, 342, 346, and 348 in CRI 344 when executed by the processing resources 332 can perform a number of functions.

Modules 337, 338, 340, 342, 346, and 348 can be sub-modules of other modules. For example, the accept module 340 and the analysis module 342 can be sub-modules and/or contained within a single module. Furthermore, modules 337, 338, 340, 342, 346, and 348 can comprise individual modules separate and distinct from one another.

A build module 337 can comprise CRI 344 and can be executed by the processing resources 332 to build a question/answer pairs corpus utilizing a directed web crawler, and a graph build module 338 can comprise CRI 344 and can be executed by the processing resources 332 to build a semantics graph including relations of concepts extracted from internal and external websites related to a user.

An accept module 340 can comprise CRI 344 and can be executed by the processing resources 332 to accept a question from the user as input and couple the input question to a concept within the semantics graph, and an analysis module 342 can comprise CRI 344 and can be executed by the processing resources 332 to analyze each question/answer pair in the corpus and couple each question/answer pair to a concept within the semantics graph.

A match module 346 can comprise CRI 344 and can be executed by the processing resources 332 to match the input question with a question/answer pair in the corpus that coupled to the same concept as the input question in the semantics graph, and an output module 348 can comprise CRI 344 and can be executed by the processing resources 332 to output to the user the matched question/answer pair. In some examples, the matched question/answer pair can include a response to a received request for information from the user.

In a number of embodiments, an identification module (not pictured) can comprise CRI 344 and can be executed by the processing resources 332 to identify a platform in a social media relevant to information technology support, and wherein the directed web crawler's design is based on the identified platform.

In some examples of the present disclosure, instructions 344 can be executable by processing resource 332 to receive a request for information from a user, crawl the user's internal website and extract a first number of concepts related to the information. In some examples, the first number of concepts can comprise content from at least one of an information technology support website of the user and a business collaboration platform of the user.

In a number of embodiments, the instructions executable to crawl the user's internal website can include instructions executable to identify a platform in a social media relevant to the requested information. The instructions executable to crawl the user's internal website can further include instructions to perform a directed crawl of predetermined portion of the user's internal website determined to be related to the user, for example.

In a number of examples, instructions 344 can be executable by processing resource 332 to create a user-centric corpus including the extracted first number of concepts, extract a second number of concepts related to the information from the corpus using a co-occurrence technique, and build a semantics graph based on relations between the second number of concepts.

Instructions 344 can be executable by processing resource 332 to organize the second number of concepts into clusters utilizing multi-view clustering and present the user with the organized second number of concepts in some examples.

A non-transitory CRM 336, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 336 can be integral, or communicatively coupled, to a computing device, in a wired and/or a wireless manner. For example, the non-transitory CRM 336 can be an internal memory, a portable memory, a portable disk, or a memory associated with another computing resource (e.g., enabling CRIs 344 to be transferred and/or executed across a network such as the Internet).

The CRM 336 can be in communication with the processing resources 332 via a communication path 360. The communication path 360 can be local or remote to a machine (e.g., a computer) associated with the processing resources 332. Examples of a local communication path 360 can include an electronic bus internal to a machine (e.g., a computer) where the CRM 336 is one of volatile, non-volatile, fixed, and/or removable storage medium in communication with the processing resources 332 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 360 can be such that the CRM 336 is remote from the processing resources, (e.g., processing resources 332) such as in a network connection between the CRM 336 and the processing resources (e.g., processing resources 332). That is, the communication path 360 can be a network connection. Examples of such a network connection can include a local area network (LAN), wide area network (WAN), personal area network (PAN), and the Internet, among others. In such examples, the CRM 336 can be associated with a first computing device and the processing resources 332 can be associated with a second computing device (e.g., a Java® server). For example, a processing resource 332 can be in communication with a CRM 336, wherein the CRM 336 includes a set of instructions and wherein the processing resource 332 is designed to carry out the set of instructions.

As used herein, “logic” is an alternative or additional processing resource to perform a particular action and/or function, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A computer-implemented method for organizing content comprising:
building a customized content corpus for a user;
building a concept graph customized for the user's context based on the customized corpus; and
organizing, utilizing multi-view clustering, the content within the corpus based on the concept graph.

2. The method of claim 1, further comprising presenting the user with the organized content grouped into navigable clusters.

3. The method of claim 1, wherein building the customized content corpus comprises crawling internal websites of the user to extract a number of concepts.

4. The method of claim 1, wherein building the customized content corpus comprises crawling websites external to the user to extract a number of concepts.

5. The method of claim 1, wherein a number of concepts are extracted from the content corpus utilizing co-occurrence.

6. The method of claim 1, wherein building the concept graph comprises building a semantics graph that reflects relations between extracted concepts.

7. The method of claim 1, wherein building the customized content corpus for the user comprises building the customized corpus using content retrieved from social media resources.

8. The method of claim 1, further comprising building a platform that accepts an information technology question from the user as input and outputs as a response content from the corpus that matches the inputted question.

9. A non-transitory computer-readable medium storing a set of instructions for organizing content executable by a processing resource to:
receive a request for information from a user;
crawl the user's internal website and extract a first number of concepts related to the information;
create a user-centric corpus including the extracted first number of concepts;
extract a second number of concepts related to the information from the corpus using a co-occurrence technique;
build a semantics graph based on relations between the second number of concepts;
organize the second number of concepts into clusters utilizing multi-view clustering; and
present the user with the organized second number of concepts.

10. The medium of claim 9, wherein the instructions executable to crawl the user's internal website comprise instructions executable to identify a platform in a social media relevant to the requested information.

11. The medium of claim 9, wherein the first number of concepts comprise content from at least one of an information technology support website of the user and a business collaboration platform of the user.

12. The medium of claim 9, wherein the instructions executable to crawl the user's internal website comprise instructions to perform a directed crawl of predetermined portion of the user's internal website determined to be related to the user.

13. A system, comprising:
a memory resource;
a processing resource coupled to the memory resource to implement:
a build module configured to build a question/answer pairs corpus utilizing a directed web crawler;
a graph build module configured to build a semantics graph including relations of concepts extracted from internal and external websites related to a user;
an accept module configured to accept a question from the user as input and couple the input question to a concept within the semantics graph;
an analysis module configured to analyze each question/answer pair in the corpus and couple each question/answer pair to a concept within the semantics graph;
a match module configured to match the input question with a question/answer pair in the corpus that coupled to the same concept as the input question in the semantics graph; and
an output module configured to output to the user the matched question/answer pair.

14. The system of claim 12, further comprising an identification module configured to identify a platform in a social media relevant to information technology support, and wherein the directed web crawler's design is based on the identified platform.

15. The system of claim 12, wherein the matched question/answer pair includes a response to a received request for information from the user.
